(19) United States
(12) Patent Application Publication
(10) Pub. No.: US 2009/0121981 A1
(43) Pub. Date: May 14, 2009

(54) Organic light emitting display device and driving method using the same

(76) Inventors: Myoung-Hwan Yoo, Suwon-si (KR); Keum-Nam Kim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/217,310

(22) Filed: Jul. 2, 2008

(30) Foreign Application Priority Data
Nov. 8, 2007 (KR) 2007-0113657

(51) Int. Cl. G09G 3/30; G06F 3/038

(52) U.S. Cl. 345/76; 345/211

(57) ABSTRACT

An organic light emitting display device is disclosed. The pixels of the display emit light which is independent of the threshold voltage of the drive transistor for the pixel. The pixel is reset before each time new data is written thereto, and the luminance data stored in the pixel includes the threshold voltage of the drive transistor.

### CROSS-REFERENCE TO RELATED APPLICATION

This application claims priority to and the benefit of Korean Patent Application No. 10-2007-0113657 filed on Nov. 8, 2007 in the Korean Intellectual Property Office, the entire content of which is incorporated herein by reference.

### BACKGROUND

1. Field

The field relates to an organic light emitting display device and a driving method using the same, and more particularly to an organic light emitting display device which resets pixels prior to compensating for a threshold voltage of a driver transistor and to inputting a data signal, and a driving method using the same.

2. Discussion of Related Technology

In recent years, an organic light emitting display device displaying an image using organic light emitting diodes that generate light through the recombination of electrons and holes has been developed and commercialized. The organic light emitting display device has advantages that it is driven with rapid response time and low power consumption.

The organic light emitting display device is generally one of two types: a passive organic light emitting display device and an active organic light emitting display device. In particular, the active organic light emitting display device is considered a next-generation display device since it is excellent in all aspect of power consumption, life span and resolution, when compared to the passive organic light emitting display device.

However, the active organic light emitting display device needs to resist deterioration of image quality by compensating for non-uniformity in a threshold voltage of a driver transistor. Also, the active organic light emitting display device needs to reset each pixel to supply a data signal to the pixels during each frame period smoothly, and stably store the data signal.

If pixels are configured to satisfy the above-mentioned benefits, the configuration of the pixels may be complicated since a plurality of transistors are formed in each of the pixels. Therefore, design of the organic light emitting display device may be complicated, its aperture ratio may be reduced, and the manufacturing cost may be increased.

### SUMMARY OF CERTAIN INVENTIVE ASPECTS

One aspect is an organic light emitting display device with a pixel unit including a plurality of pixels disposed near intersecting points of scan lines and data lines, where the pixel unit is driven with a scan signal and a data signal for each of the scan lines and the data lines and first and second pixel power sources. The display also includes a first power supply line configured to supply the first pixel power source to the pixels, and one or more control transistors coupled between the first power supply line and at least two pixels coupled to the same scan line, the control transistors configured to control the electrical connection between the first power supply line and the pixels coupled to the control transistor.

Another aspect is a method of driving an organic light emitting display device having a first power supply line configured to supply power to a plurality of pixels coupled to scan lines and data lines, each pixel including an organic light emitting diode. The method includes sequentially supplying a scan signal to the scan lines while supplying a data signal to the data lines, and causing the pixels emit light with brightness corresponding to the data signal, where the pixels are isolated from the first power supply line while the scan and data signals are supplied and the pixels are connected to the first power supply line while the pixels emit light.

Another aspect is an organic light emitting display device with a pixel unit including a plurality of pixels, each of the pixels including a reservoir capacitor configured to be reset and to be charged with a data signal, and an organic light emitting diode configured to emit light according to the data signal, and a control transistor configured to couple a selected pixel to a power supply line while the reservoir capacitor of the selected pixel is being reset and while the reservoir capacitor of the selected pixel is being charged with the data signal, and the control transistor is configured to isolate the selected pixel while the organic light emitting diode of the selected pixel emits light.

### BRIEF DESCRIPTION OF THE DRAWINGS

These and/or other embodiments and features will become apparent and more readily appreciated from the description of certain exemplary embodiments, taken in conjunction with the accompanying drawings of which:

FIG. 1 is a block view showing an organic light emitting display device according to one embodiment.

FIG. 2 is a circuit view showing one embodiment of a pixel of FIG. 1.

FIG. 3 is a waveform view showing a method of driving a pixel.

FIG. 4 is a block view showing an organic light emitting display device according to another embodiment.

FIG. 5 is a circuit view showing an embodiment of a pixel.

FIG. 6 is a waveform view showing a method of driving the pixel of FIG. 5.

FIG. 7 is diagram view showing an organic light emitting display device according to another embodiment.

### DETAILED DESCRIPTION OF CERTAIN INVENTIVE EMBODIMENTS

Hereinafter, certain exemplary embodiments will be described with reference to the accompanying drawings. Herein, when a first element is described as being coupled to a second element, the first element may be not only directly coupled to the second element but may also be indirectly coupled to the second element via a third element. Further, elements that are not essential to the complete understanding of the invention are omitted for clarity. Also, like reference numerals refer to like elements throughout.

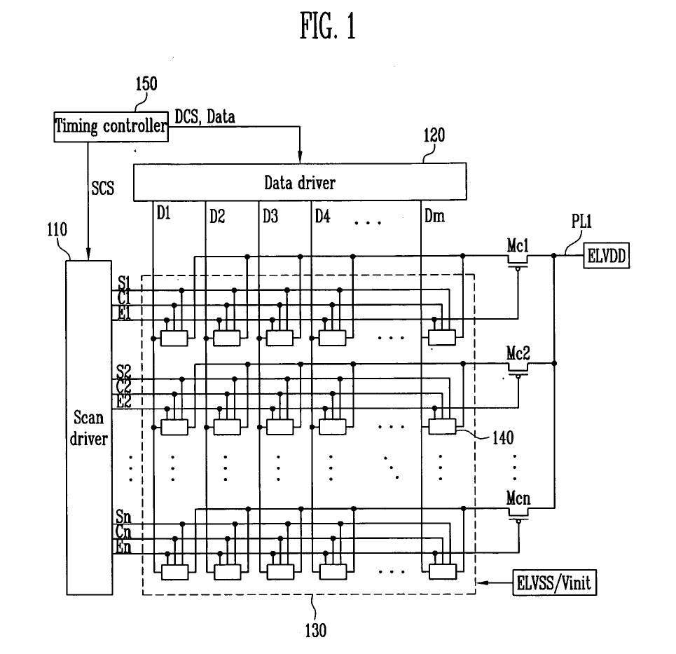

FIG. 1 is a block view showing an organic light emitting display device according to one exemplary embodiment. FIG. 1 shows the organic light emitting display device in which a separate reset power source in addition to first and second pixel power sources is supplied to a pixel unit and each of the pixels is reset by a reset control signal supplied to reset control lines. However, the present invention is not limited thereto.

Referring to FIG. 1, the organic light emitting display device includes a pixel unit 130 including a plurality of pixels 140 disposed near intersection points of scan lines (S1 to Sn) and data lines (D1 to Dm); a scan driver 110 for driving the scan lines (S1 to Sn); a data driver 120 for driving the data lines (D1 to Dm); and a timing controller 150 for controlling the scan driver 110 and the data driver 120.

The pixel unit 130 includes a plurality of pixels 140 formed in a region having scan lines (S1 to Sn), data lines (D1 to Dm), reset control lines (C1 to Cn) and light-emission control lines (E1 to En).

Each of the pixels 140 is driven according to a scan signal, data signal, reset control signal and light-emission control signal supplied respectively to the scan line (S), the data line (D), the reset control line (C) and the light-emission control line (E), all of which are coupled to each of the pixels 140. First and second pixel power sources (ELVDD, ELVSS), and a reset power source (Vinit) are also applied to the pixels 140.

The scan driver 110 receives a scan drive control signal (SCS) from the timing controller 150 and generates a scan signal, a light-emission control signal and a reset control signal according to the received scan drive control signal (SCS). And, the scan driver 110 supplied the generated scan signal, light-emission control signal and reset control signal to scan lines (S1 to Sn), light-emission control lines (E1 to En) and reset control lines (C1 to Cn), respectively.

This exemplary embodiment shows that a scan signal, a light-emission control signal and a reset control signal are generated in one scan driver 110, but the present invention is not limited thereto. For example, the light-emission control signal and/or the reset control signal may be generated in separate drive circuits.

The data driver 120 receives a data drive control signal (DCS) and a data (Data) from the timing controller 150 and generates a data signal corresponding to the data drive control signal (DCS) and the data (Data). The data driver 120 also supplies the generated data signal to the data lines (D1 to Dm) synchronized with a scan signal.

The timing controller 150 generates a scan drive control signal (SCS) and a data drive control signal (DCS) corresponding to synchronizing signals supplied from another circuit. The scan drive control signal (SCS) generated in the timing controller 150 is supplied to the scan driver 110, and the data drive control signal (DCS) is supplied to the data driver 120. Also, the timing controller 150 supplies a data (Data) supplied from another circuit to the data driver 120.

A first power supply line (PL1) for supplying a first pixel power source (ELVDD) to the pixels 140 is electrically coupled to each of the pixels 140 through the control transistor (Mc).

The control transistor (Mc) isolates the pixels 140 from the first power supply line (PL1), or connects the pixels 140 to the first power supply line (PL1) according to a control signal supplied to a gate electrode of the control transistor (Mc).

At least one control transistor (Mc) is connected to pixels which share the same scan line (S). Accordingly, the control transistor (Mc) controls the coupling between the first power supply line (PL1) and the pixels 140.

In some embodiments, the control transistor (Mc) is formed outside the pixel unit 130 and connected to pixels 140 sharing the same scan line (S), as shown in FIG. 1. Accordingly, the pixels 140 coupled to the same scan line (S) may be electrically coupled to or insulated from the first power supply line (PL1) at the same time.

The control transistors (Mc) may be controlled by the light-emission control signal to supply a first pixel power source (ELVDD) during a period when the pixels 140 are to emit light. Accordingly, the gate electrode of the control transistors (Mc) are coupled to the light-emission control line (E) that is coupled to the pixels 140 coupled to the control transistors (Mc). As a result, the control transistors (Mc) are set so that they can be turned on or off by the light-emission control signal supplied from the light-emission control line (E). With this arrangement, there is no need for an additional signal to drive the control transistors (Mc).

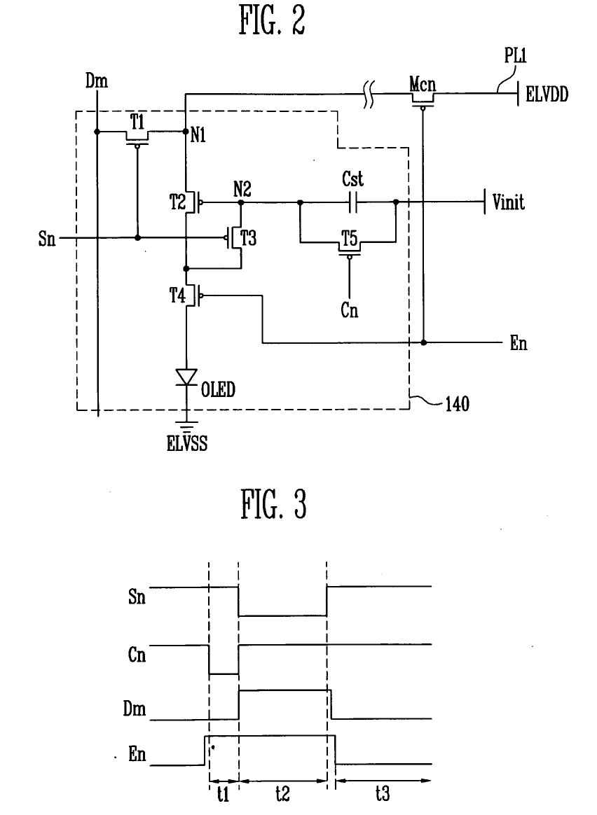

FIG. 2 is a circuit view showing one example of a pixel as shown in FIG. 1. For the sake of convenience, FIG. 2 shows a pixel coupled to an n^{th} scan line and an m^{th} data line.

Referring to FIG. 2, the pixel 140 includes first to fifth transistors (T1 to T5), a reservoir capacitor (Cst) and an organic light emitting diode (OLED). And, the pixel 140 is coupled to a first power supply line (PL1) through a control transistor (Mcn) formed outside the pixel 140.

More particularly, the first transistor (T1) is coupled between a data line (Dm) and a first node (N1). Here, the first node (N1) is a node to which the first transistor (T1), a second transistor (T2) and a control transistor (Mcn) are all coupled. And, the gate electrode of the first transistor (T1) is coupled to the scan line (Sn). The first transistor (T1) is turned on when a scan signal is applied to transmit a data signal, from the data line (Dm) to the first node (N1).

The second transistor (T2) is coupled between the first node (N1) and a fourth transistor (T4), and the gate electrode of the second transistor (T2) is coupled to a second node (N2). Here, the second node (N2) is a node to which a second transistor (T2), a third transistor (T3), a fifth transistor (T5) and a reservoir capacitor (Cst) are all coupled. The second transistor (T2) controls a current that flows from the first node (N1) to the fourth transistor (T4) according to a voltage supplied to the gate electrode of the second transistor (T2). The second transistor (T2) operates as a driver transistor in the pixel 140.

The third transistor (T3) is coupled between the gate electrode and a second electrode (for example, a drain electrode) of the second transistor (T2), and the gate electrode of the third transistor (T3) is coupled to the scan line (Sn). The third transistor (T3) is turned on when a scan signal is supplied from the scan line (Sn), thereby diode-coupling the second transistor (T2).

The fourth transistor (T4) is coupled between the second transistor (T2) and the organic light emitting diode (OLED), and the gate electrode of the fourth transistor (T4) is coupled to the light-emission control line (En). The fourth transistor (T4) is turned off during a period when a light-emission control signal is supplied from the light-emission control line (En) (for example, when a light-emission control signal is set to a high level). The fourth transistor (T4) prevents an electric current, supplied from the second transistor (T2), from being supplied to the organic light emitting diode (OLED) during this period. The fourth transistor (T4) is turned on during a period when a light-emission control signal is not supplied from the light-emission control line (En) (for example, a light-emission control signal is set to a low level). The fourth transistor (T4) supplies an electric current, from the second transistor (T2) to the organic light emitting diode (OLED) in this period.

The fifth transistor (T5) is coupled between both electrodes of the reservoir capacitor (Cst). And, the gate electrode of the fifth transistor (T5) is coupled to a reset control line (Cn). The fifth transistor (T5) is turned on during a period when a reset control signal is supplied from the reset control line (Cn), thereby resetting the second node (N2).

The reservoir capacitor (Cst) is coupled between the second node (N2) and the reset power source (Vinit). The reservoir capacitor (Cst) stores a voltage corresponding to a data signal supplied via the first, second and third transistors (T1 to T3) when a scan signal is supplied to the reservoir capacitor (Cst), and then maintains the stored voltage during one frame period.

The organic light emitting diode (OLED) is coupled between the fourth transistor (T4) and the second pixel power source (ELVSS). The organic light emitting diode (OLED) generates light corresponding to a current supplied from the first pixel power source (ELVDD) via the control transistor (Mcn) and the second and fourth transistors (T2, T4).

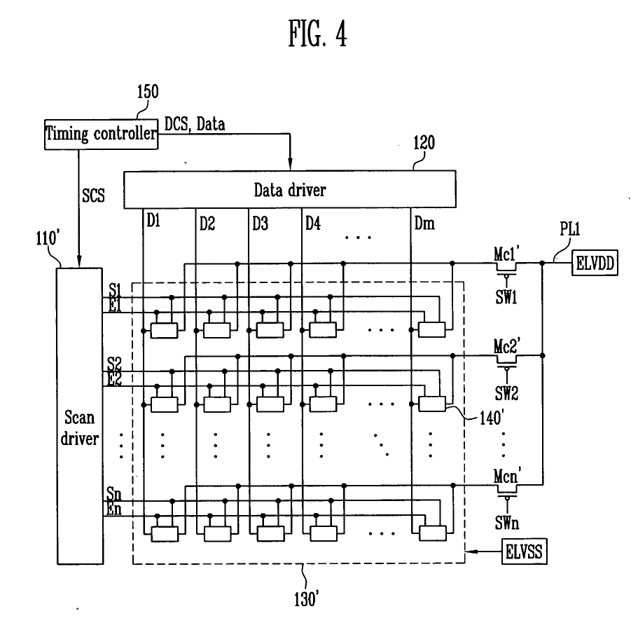

FIG. 3 is a waveform view showing a method of driving a pixel as shown in FIG. 2. Hereinafter, the method of driving a pixel as shown in FIG. 2 will be described in detail, in combination with FIG. 2 and FIG. 3.

A high level of a scan signal, a low level of reset control signal and data signal, and a high level of a light-emission control signal are supplied respectively to a scan line (Sn), a reset control line (Cn), a data line (Dm) and a light-emission control line (En) during a first period (t1). In this example, the data signal is a high level. And, the reset control signal may be generated using a previous scan signal, or generated by a separate start pulse.

During this first period (t1), the fifth transistor (T5) is turned on by a low level of the reset control signal. Therefore, since the second node (N2) is coupled to a reset power source (Vinit) and then reset, a data signal is supplied to the pixel 140 regardless of the previous data signal during each frame period. The first period (t1) is used to reset the second node (N2).

During the second period (t2), a low level of a scan signal, a high level of a reset control signal, a data signal and a light-emission control signal are supplied respectively to the scan line (Sn), the reset control line (Cn), the data line (Dm) and the light-emission control line (En).

During the second period (t2), the first and third transistors (T1, T3) are turned on by a low level of the scan signal and the second transistor (T2) diode-coupled by the third transistor (T3) is also turned on. Therefore, a data signal supplied from the data line (Dm) is supplied to the second node (N2) via the first, second and third transistors (T1 to T3). Here, the second transistor (T2) is diode-coupled by the third transistor (T3). Accordingly, a voltage is supplied to the second node (N2), the voltage corresponding to the data signal and the threshold voltage of the second transistor (T2).

The voltage of the second node (N2) is stored in the reservoir capacitor (Cst). Accordingly, the second period (t2) is used to store the data signal and the threshold voltage of the driver transistor (the second transistor, T2).

During the third period (t3), a high level of a scan signal and a reset control signal, and a low level of a data signal and a light-emission control signal are supplied respectively to the scan line (Sn), the reset control line (Cn), the data line (Dm) and the light-emission control line (En).

During the third period (t3), the control transistor (Mcn) and the fourth transistor (T4) are turned on by a low level of the light-emission control signal.

When the control transistor (Mcn) is turned on, the first power supply line (PL1) is coupled to a first node (N1) in the pixel 140 to supply a first pixel power source (ELVDD) to the first node (N1).

And, When the fourth transistor (T4) is turned on, an electric current corresponding to the voltage stored in the reservoir capacitor (Cst) flows from the first pixel power source (ELVDD) to the second pixel power source (ELVSS) via the second and fourth transistors (T2, T4) and the organic light emitting diode (OLED). As a result, the organic light emitting diode (OLED) emits light corresponding to the data signal.

The organic light emitting display device according to some exemplary embodiments as shown above in FIGS. 1 to 3, the driver transistor may compensate for a threshold voltage of the driver transistor by being diode-coupled. Therefore, the display does not suffer from deterioration of image quality caused by non-uniformity in a threshold voltage of the driver transistor.

Also, the second node (N2) is reset using the reset power source (Vinit) and the fifth transistor (T5), prior to inputting the data signal. As a result, a data signal may be accurately supplied into the pixel 140 during each frame period.

Also, when a voltage corresponding to a data signal is stored in the reservoir capacitor (Cst), an electric current is prevented from flowing in the organic light emitting diode (OLED) by the fourth transistor (T4). Therefore, the data signal is stably stored in the reservoir capacitor (Cst).

In addition, the pixel 140 may be configured with a relatively low number of transistors while performing the functions of compensating for compensation the threshold voltage of the driver transistor (T2), effective resetting of the pixel 140 and stably storing the data signal.

In addition, a short between the first pixel power source (ELVDD) and the data voltage is prevented during the period when the scan signal is supplied. During the period when the pixel 140 is allowed to emit the light, the control transistor (Mc) supplies the first pixel power source (ELVDD) to a plurality of pixels 140. Therefore, the configuration of the pixel 140 may be simple because of having few transistors in the pixel 140 while allowing each of the pixels 140 to perform the desired functions.

Accordingly, the organic light emitting display device may be easily designed, its aperture ratio may be high and the manufacturing cost may be low.

The control transistors (Mc) are formed so as to connect the first power source (ELVDD) to a plurality of pixels 140 sharing the same scan line (S). Accordingly, each of the control transistors (Mc) is formed with a suitable size to conduct the electric current flowing in the organic light emitting diode (OLED) without a large voltage drop across the control transistors (Mc). However, the size of the control transistor (Mc) may be varied according to the size of the display device and the driving method, and therefore it is unnecessary to limit the size or capacity of the control transistor (Mc) to a certain range.

FIG. 4 is a block view showing an organic light emitting display device according to another exemplary embodiment. In FIG. 4, the parts corresponding to those in FIG. 1 generally have the same reference numerals, and descriptions of the same parts may be omitted.

Referring to FIG. 4, a pixel unit 130′ of the organic light emitting display device includes a plurality of pixels 140′ disposed near intersection points of scan lines (S1 to Sn), light-emission control lines (E1 to En) and data lines (D1 to Dm).

The organic light emitting display device does not include an additional reset power source and reset control lines, unlike the organic light emitting display device as shown in FIG. 1. Also, a scan driver 110′ generates a scan signal and a light-emission control signal.

In this exemplary embodiment, control transistors (Mc1′ to Mcn′) are set to be turned on during a period when the pixel 140′ coupled to the control transistors (Mc1′ to Mcn′) emits light according to a switching signal.

For this purpose, the gate electrodes of the control transistors (Mc1′ to Mcn′) are coupled to switching signal supply lines (SW1 to SWn). Therefore, the control transistors (Mc1′ to Mcn′) are turned on and off by the switching signal supplied from the switching signal supply lines (SW1 to SWn). The switching signal may be, for example, generated in the scan driver 110′, or generated in a separate drive circuit.

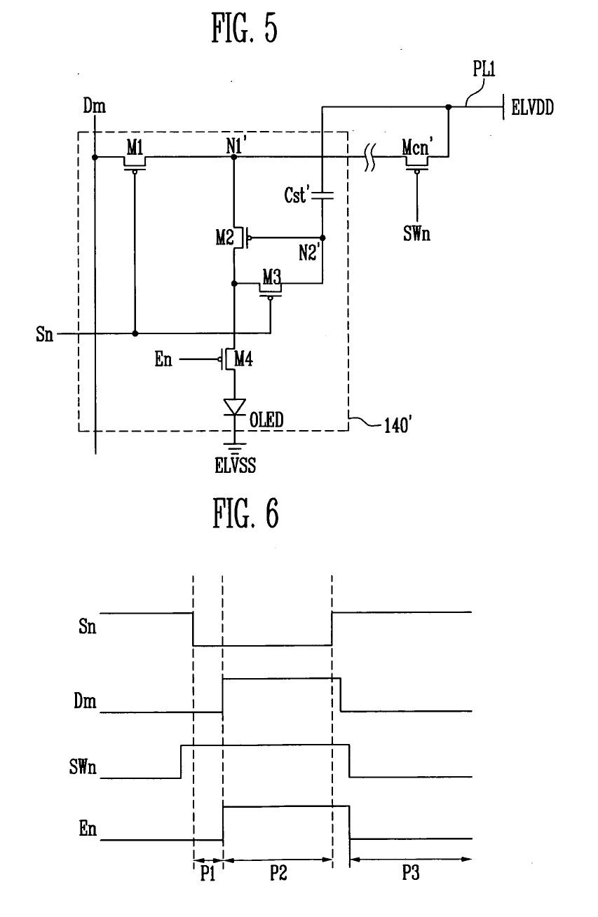

FIG. 5 is a circuit view showing one example of a pixel as shown in FIG. 4. For the sake of convenience, FIG. 5 shows a pixel coupled to an n^{th} scan line and an m^{th} data line.

Referring to FIG. 5, the pixel 140′ includes first to fourth transistors (M1 to M4), a reservoir capacitor (Cst′) and an organic light emitting diode (OLED), and is coupled to a first power supply line (PL1) through a control transistor (Mcn′) formed outside the pixel 140′.

The first transistor (M1) is coupled between a data line (Dm) and a first node (N1′). The first node (N1′) is a connected to a first transistor (M1), a second transistor (M2) and a control transistor (Mcn′). The gate electrode of the first transistor (M1) is coupled to the scan line (Sn). The first transistor (M1) is turned on when a scan signal is supplied to the scan line (Sn), thereby transmitting a data signal, supplied from the data line (Dm), to the first node (N1′).

The second transistor (M2) is coupled between the first node (N1′) and a fourth transistor (M4), and the gate electrode of the second transistor (M2) is coupled to a second node (N2′). Here, the second node (N2′) is connected to the second transistor (M2), a third transistor (M3) and a reservoir capacitor (Cst′). The second transistor (M2) controls a current flowing from the first node (N1′) to the fourth transistor (M4) correspond to a voltage at the gate electrode of the second transistor (M2). Accordingly, the second transistor (M2) operates as a driver transistor in the pixel 140′.

The third transistor (M3) is coupled between the gate electrode and a second electrode of the second transistor (M2), and the gate electrode of the third transistor (M3) is coupled to the scan line (Sn). The third transistor (M3) is turned on when a scan signal is supplied to the scan line (Sn), thereby diode-coupling the second transistor (M2).

The fourth transistor (M4) is coupled between the second transistor (M2) and the organic light emitting diode (OLED), and the gate electrode of the fourth transistor (M4) is coupled to the light-emission control line (En). The fourth transistor (M4) is turned off during a period when a light-emission control signal is supplied to the light-emission control line (En) (for example, when a light-emission control signal is set to a high level). Therefore, the fourth transistor (M4) prevents electric current from flowing in the organic light emitting diode (OLED). And, the fourth transistor (M4) is turned on when the light-emission control signal is not supplied from the light-emission control line (En) (for example, when a light-emission control signal is set to a low level). Therefore, the fourth transistor (M4) supplies an electric current, from the second transistor (M2), to the organic light emitting diode (OLED).

The reservoir capacitor (Cst′) is coupled between the second node (N2′) and the first power supply line (PL1). The reservoir capacitor (Cst′) stores a voltage corresponding to the data signal supplied via the first to third transistors (M1 to M3) when a scan signal is supplied. And, the reservoir capacitor (Cst′) maintains the stored voltage during one frame period.

The organic light emitting diode (OLED) is coupled between the fourth transistor (M4) and the second pixel power source (ELVSS). The organic light emitting diode (OLED) generates light that corresponds to the current supplied from the first power source (ELVDD) via the control transistor (Mcn′), the first node (N1′), and the second and fourth transistors (M2, M4).

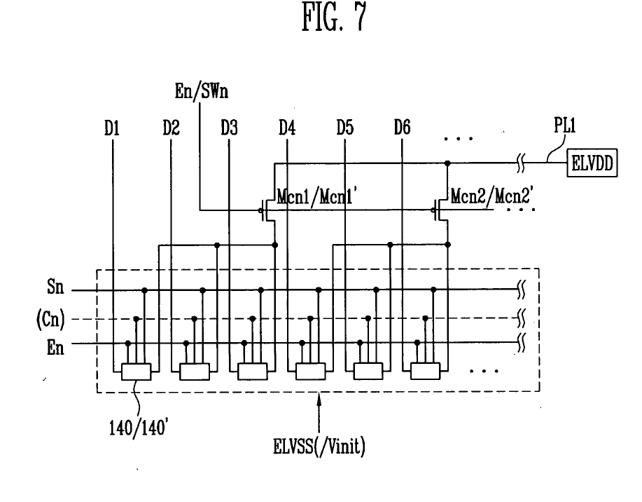

FIG. 6 is a waveform view showing a method of driving the pixel shown in FIG. 5. Hereinafter, the method of driving the pixel will be described with reference to FIG. 5 and FIG. 6.

During a first period (P1), a low level of a scan signal and a data signal, a high level of a switching signal and a low level of a light-emission control signal are supplied respectively to a scan line (Sn), a data line (Dm), a switching signal supply line (SWn) and a light-emission control line (En).

During the first period (P1), first, third and fourth transistors (M1, M3, M4) are turned on in response to a low level of the scan signal and the light-emission control signal. As a result, the data signal is not input into the pixel 140′ since the data signal is set to a low level even when the first transistor (M1) is turned on.

The second node (N2′) is coupled to the second pixel power source (ELVSS) and therefore reset when the third and fourth transistors (M3, M4) are turned on. Accordingly, the first period (P1) is used for resetting the second node (N2′).

Then, during the second period (P2), a low level of a scan signal, a high level of a data signal, a switching signal and a light-emission control signal are supplied respectively to the scan line (Sn), the data line (Dm), the switching signal supply line (SWn) and the light-emission control line (En).

During the second period (P2), the first and third transistors (M1, M3) remain on because of the low level of the scan signal. And, the second transistor (M2) is diode-coupled by the third transistor (M3).

The data signal from the data line (Dm) is supplied to the second node (N2′) via the first transistor (M1), the second transistor (M2) and the third transistor (M3). The second transistor (M2) and the third transistor (M3) operate like diode. Accordingly, a voltage is supplied to the second node (N2′), the voltage corresponding to the data signal and the threshold voltage of the second transistor (a driver transistor) (M2). Therefore, the voltage corresponding to the data signal and the threshold voltage of the second transistor (M2) is stored in the reservoir capacitor (Cst′).

During the third period (P3), a high level of a scan signal and a low level of a data signal, a switching signal and a light-emission control signal are supplied respectively to the scan line (Sn), the data line (Dm), the switching signal supply line (SWn) and the light-emission control line (En).

During the third period (P3), the control transistor (Mcn′) and the fourth transistor (M4) are turned on by a low level of the switching signal and the light-emission control signal.

If the control transistor (Mcn′) is turned on, the first node (N1′) is coupled to the first power supply line (PL1) to supply the first pixel power source (ELVDD) to the first node (N1′).

In addition, if the fourth transistor (M4) is turned on, an electric current flows from the first pixel power source (ELVDD) to the second pixel power source (ELVSS) via the first node (N1′), the second and fourth transistors (M2, M4) and the organic light emitting diode (OLED), the electric current corresponding to the voltage stored in the reservoir capacitor (Cst′).

In response, the organic light emitting diode (OLED) emits light with luminance corresponding to the data signal.

The organic light emitting display device according to some embodiments, as shown above in FIGS. 4 to 6 may prevent deterioration of image quality caused by non-uniformity in the threshold voltage of the driver transistors of the pixels. Also, the pixel 140′ may be reset prior to inputting the data signal, and the data signal may, therefore, be reliably stored prior to the light emission.

In addition, the pixel 140 may be configured with a relatively low number of transistors while performing the above-mentioned operations.

In addition, a short between the first pixel power source (ELVDD) and a data voltage is prevented during the period when the scan signal is supplied. During the period when the pixels 140′ emits light, the control transistor (Mc′) couples the first pixel power source (ELVDD) to the first node (N1′) of the plurality of pixels 140′. Therefore, a configuration of the pixel 140′ may have a low number of transistors while allowing each of the pixels 140′ to perform the described functions. During the period when the control transistor (Mc′) is turned off, a signal line to which the control transistor (Mc′) and the driver transistor (M2) are coupled is also used as a signal line into which a data signal is input.

Accordingly, the organic light emitting display device may be easily designed, its aperture ratio may be high and the manufacturing cost may be low.

The above-mentioned exemplary embodiments show that one of the control transistors (Mc/Mc′) is formed for all pixels sharing a single scan line, but the present invention is not limited thereto.

For example, the control transistors (Mc/Mc′) may be connected to smaller groups of pixels coupled to the same scan line.

For example, it is possible to sequentially divide the pixels (140/140′) coupled to one scan line (for example, an n^{th} scan line (Sn)) into two groups, and form a plurality of control transistors (Mc/Mc′) that control the coupling between each of the pixel groups and the first power supply line (PL1), as shown in FIG. 7.

The pixels (140/140′) coupled to the same scan line (S) are generally turned on at substantially the same time, and therefore the control transistors (Mc/Mc′) formed in the same row are set so that they can be turned on or off at substantially the same time. For this purpose, these gate electrodes may be commonly coupled to the same control line (for example, a light-emission control line (E) or a switching signal supply line (SW)). However, the present invention is not limited thereto, and it is considered that various changes and modification may be made.

Although exemplary embodiments of the present invention have been shown and described, it would be appreciated by those skilled in the art that changes might be made in these embodiments without departing from the principles and spirit of the invention.

What is claimed is:

1. An organic light emitting display device, comprising:
a pixel unit including a plurality of pixels disposed near intersecting points of scan lines and data lines, wherein the pixel unit is driven with a scan signal and a data signal for each of the scan lines and the data lines and first and second pixel power sources;
a first power supply line configured to supply the first pixel power source to the pixels; and
one or more control transistors coupled between the first power supply line and at least two pixels coupled to the same scan line, the control transistors configured to control the electrical connection between the first power supply line and the pixels coupled to the control transistor.

2. The organic light emitting display device according to claim 1, wherein at least one of the control transistors is coupled to all of the pixels of one of the scan lines.

3. The organic light emitting display device according to claim 1, wherein a plurality of the control transistors are each coupled to a portion of all of the pixels of one of the scan lines.

4. The organic light emitting display device according to claim 1, wherein at least one of a plurality of light-emission control lines and a plurality of reset control lines is further formed in the pixel unit.

5. The organic light emitting display device according to claim 4, wherein each of the control transistors is configured to be turned on and off by the light-emission control signal.

6. The organic light emitting display device according to claim 4, wherein each of the pixels comprise:
a first transistor coupled between the data line and the control transistor, wherein the gate of the first transistor is coupled to the scan line;
an organic light emitting diode coupled between the second pixel power source and a first node to which the first transistor and the control transistor are coupled;
a second transistor coupled between the first node and the organic light emitting diode, wherein the gate of the second transistor is coupled to a second node;
a third transistor coupled between the gate electrode and the second node, wherein the gate of the third transistor is coupled to the scan line;
a fourth transistor coupled between the second transistor and the organic light emitting diode, wherein the gate of the fourth transistor is to the light-emission control line;
a reservoir capacitor coupled between the second node and a reset power source; and
a fifth transistor coupled between both electrodes of the reservoir capacitor, wherein the fifth transistor is coupled to the reset control line.

7. The organic light emitting display device according to claim 1, wherein each of the control transistors is turned on and off by a switching signal supplied to a gate electrode thereof, and
wherein the switching signal is configured to turn on the control transistors during a period when the pixels emit light.

8. The organic light emitting display device according to claim 7, wherein light-emission control lines configured to supply a light-emission control signal to the pixels are further formed in the pixel unit.

9. The organic light emitting display device according to claim 8, wherein each of the pixels comprises:
a first transistor coupled between the data line and the control transistor, wherein the gate of the first transistor is coupled to the scan line;
an organic light emitting diode coupled between the second pixel power source and a first node to which the first transistor and the control transistor are coupled;
a second transistor coupled between the first node and the organic light emitting diode, wherein the gate electrode of the second transistor is connected to a second node;
a third transistor coupled between the gate electrode and the second electrode of the second transistor, the gate electrode of the third transistor is coupled to the scan line;
a fourth transistor coupled between the second transistor and the organic light emitting diode, wherein the gate electrode of the fourth transistor is coupled to the light-emission control line; and
a reservoir capacitor coupled between the second node and the first power supply line.

10. A method of driving an organic light emitting display device having a first power supply line configured to supply power to a plurality of pixels coupled to scan lines and data lines, each pixel including an organic light emitting diode, the method comprising:
sequentially supplying a scan signal to the scan lines while
supplying a data signal to the data lines; and causing the pixels emit light with brightness corresponding to the data signal,
wherein the pixels are isolated from the first power supply line while the scan and data signals are supplied and the pixels are connected to the first power supply line while the pixels emit light.

11. The method of driving an organic light emitting display device according to claim 10, wherein pixels coupled to the same scan line are coupled to power supply line with a control transistor.

12. The method of driving an organic light emitting display device according to claim 10, wherein a light-emission control signal configured to control the light emission of the pixels is further supplied to the pixels, and the coupling between the pixels and the first power supply line is controlled by the light-emission control signal.

13. The method of driving an organic light emitting display device according to claim 10, wherein a control signal is further supplied to the pixels to control the coupling between the pixels and the power supply line.

14. An organic light emitting display device, comprising:
a pixel unit including a plurality of pixels, each of the pixels comprising:
a reservoir capacitor configured to be reset and to be charged with a data signal; and
an organic light emitting diode configured to emit light according to the data signal; and
a control transistor configured to isolate a selected pixel to a power supply line while the reservoir capacitor of the selected pixel is being reset and while the reservoir capacitor of the selected pixel is being charged with the data signal, and the control transistor is configured to connect the selected pixel while the organic light emitting diode of the selected pixel emits light.

15. The organic light emitting display device according to claim 14, further comprising a plurality of control transistors, wherein each of the pixels is connected to one of a plurality of scan lines, and each control transistor is connected to a plurality of pixels coupled to the same scan line.

16. The organic light emitting display device according to claim 14, wherein each of the organic light emitting diodes is to emit light based at least in part on the state of a light-emission control signal, and each of the control transistors is configured to be turned on and off by the light-emission control signal.

17. The organic light emitting display device according to claim 14, wherein each of the pixels further comprise:
a first transistor configured to connect the reservoir capacitor to a data line configured to supply the data signal;
a second transistor configured to supply a current to the organic light emitting diode according to the data signal;
a third transistor configured to diode connect the second transistor; and
a fourth transistor configured to connect the organic light emitting diode to the second transistor.

18. The organic light emitting display device according to claim 17, wherein the second transistor is diode connected by the third transistor when the reservoir capacitor is being reset.

19. The organic light emitting display device according to claim 17, wherein the second transistor is diode connected by the third transistor when the reservoir capacitor is being charged with the data signal.
